(19) United States
(12) Patent Application Publication
(10) Pub. No.: US 2008/0294454 A1
(43) Pub. Date: Nov. 27, 2008

(54) DISPLAY OF CLINICAL INFORMATION

(76) Inventor: Basel Taha, Arlington Heights, IL (US)

Correspondence Address: MCANDREWS HELD & MALLOY, LTD, 500 WEST MADISON STREET, SUITE 3400, CHICAGO, IL, 60661, US

(21) Appl. No.: 11/751,933

(22) Filed: May 22, 2007

(51) Int. Cl. G06Q 50/00

(52) U.S. Cl. 705/2

(57) ABSTRACT

Certain embodiments of the present invention provide a system for presenting clinical information comprising: a plurality of pages for displaying clinical information; and a plurality of sources for said clinical information, wherein each of said pages is capable of receiving information from at least one of said sources, and each of said pages is capable of dynamically updating the display of said clinical information. In an embodiment, plurality of pages are capable of displaying said clinical information without substantial electrical power. In an embodiment, each of said plurality of pages is flexible. In an embodiment, each of said plurality of pages comprise organic light emitting diodes. In an embodiment, said clinical information comprises linked clinical data corresponding to a patient. In an embodiment, said clinical information comprises unlinked clinical data corresponding to a patient.

### BACKGROUND OF THE INVENTION

Embodiments of the present application relate generally to dynamic display of clinical information. Particularly, certain embodiments relate to dynamic display of clinical information on a chart having two or more pages.

Some studies have demonstrated the improved patient outcomes by use of computerized clinical information systems. However, many barriers may persist to the wide adoption of such computerized clinical information systems in clinical practice. One such barrier is cost of implementation. Another barrier is clinician adoption. Clinician adoption may be related to usability of computerized clinical information systems.

Physicians and nurses used to the speed of flipping through a paper chart to access and document patient data may need to adjust or completely be retrained on the way they work to accommodate the design of a computerized system and it's display and aggregation of patient data. Some studies that evaluated the efficiency of existing computerized physician order entry systems have pointed to increased time in managing orders electronically versus paper. Other studies have identified potential problems with the use of computerized provider order entry (CPOE) systems due to difficulties in the presentation of relevant data (e.g., fragmented display of order data).

One of the challenges to clinical data presentation is how to display and link relevant information in a manner that is quickly and reliably accessible to a clinician. Data may be provided from multiple sources. Displaying and linking data from multiple sources may be difficult on a single screen. Multiple modules may be required to present multiply sourced data on a single screen. Switching among different modules on a single screen may require multiple interactions (e.g., mouse clicks), and may be time consuming. Such switching may complicate clinical analysis. Furthermore, implementing multiple monitors (e.g., cathode ray tube screens or flat panel screens) consumes valuable space and resources in a clinical enterprise.

One solution to the challenge of making disparate clinical data available to the clinician may focus on building intelligence into a product design so that relevant information is available either on a single screen or switching among screens. Some advances have been made with clinical decision support and intelligent visualization. However, there is a limit as to how much data may be presented on one screen. Certain clinical information systems today may require the navigation across several screens through clicking, scrolling or panning. Designers of such systems may continue to seek ways to reduce mouse clicks and use pop-ups in an effort to speed the navigation. These systems may still fall short of approaching paper speed, or may require a high level of skill (e.g. computer literacy, software familiarity, experience) by the clinician.

At the same time, advances in display technology offer new promise. One such technology is organic light emitting diode (OLED) displays. Some example properties of OLED displays include: the ability to function without backlighting; the ability to have flexible displays; the ability to present information to a viewer without the application of power. It may be possible, therefore, to arrive at innovative solutions using OLED displays to dynamically present clinical information.

Thus, there is a need for convenient management of clinical information. There is a need for provision of clinical information management in a relatively small factor. There is a need to lower the resistance threshold of clinical caregivers and speed the adoption of computerized clinical systems. There is a need for mechanical navigation that is more natural to clinicians. Additionally, there is a need for easing the burden of data interoperability among multiple clinical data sources.

### BRIEF SUMMARY OF THE INVENTION

Certain embodiments of the present invention provide a system for presenting clinical information including: a plurality of pages for displaying clinical information; and a plurality of sources for the clinical information, wherein each of the pages is capable of receiving information from at least one of the sources, and each of the pages is capable of dynamically updating the display of the clinical information. In an embodiment, plurality of pages are capable of displaying the clinical information without substantial electrical power. In an embodiment, each of the plurality of pages is flexible. In an embodiment, each of the plurality of pages include organic light emitting diodes. In an embodiment, the clinical information includes linked clinical data corresponding to a patient. In an embodiment, the clinical information includes unlinked clinical data corresponding to a patient. In an embodiment the clinical information includes clinical data corresponding to a patient, the clinical data further including plurality of sources, the sources further including at least two of: a lab result, an allergy report, a patient history, and a medication management system report.

Certain embodiments of the present invention provide an apparatus for presenting clinical information including: an axial portion; a first page for viewing by a clinician, the page rotatably attached to the axial portion; a second page for viewing by the clinician, the second page rotatably attached to the axial portion; and at least one data conduit for receiving clinical information into the apparatus from a plurality of sources, wherein the clinical information is dynamically displayed on at least one of: the first page, and the second page. In an embodiment, each of the first and second pages is capable of displaying the clinical information without substantial electrical power. In an embodiment, each of the first and second pages is flexible. In an embodiment, each of the first and second pages include organic light emitting diodes. In an embodiment, at least one of the first and second pages is detachable from the axial portion, and is capable of displaying the clinical information while detached. In an embodiment, the clinical information includes clinical data corresponding to a patient, the clinical data further including plurality of sources, the sources further including at least two of: a lab result, an allergy report, a patient history, and a medication management system report. In an embodiment, the apparatus further includes an interface for permitting interaction with the clinician to alter a display of at least one of the first and second pages. In an embodiment, the interface includes a touch screen in at least one of the first and second pages. In an embodiment, the first and second pages are capable of displaying at least one of: linked clinical information, and unlinked clinical information.

Certain embodiments of the present invention provide a method for displaying clinical information including: receiving a first set of clinical information from a first source; receiving a second set of clinical information from a second source; and displaying dynamically the first and second sets of clinical information on a plurality of pages, wherein the plurality of pages are attachably linked to a clinical display device. In an embodiment, the method further includes substantially removing power to at least one of the plurality of pages to display at least one of the first and second sets of clinical information. In an embodiment, the method further includes detaching at least one of the plurality of pages from the clinical display device to form a detached page, wherein the detached page is capable of displaying at least one of the first and second sets of clinical information. In an embodiment, the method further includes interacting with at least one of the sets of clinical information.

### BRIEF DESCRIPTION OF SEVERAL VIEWS OF THE DRAWINGS

FIG. 1 shows a system for displaying clinical information, according to an embodiment of the present invention.

FIG. 2 shows an apparatus for displaying clinical information, according to an embodiment of the present invention.

FIG. 3 shows a flowchart for a method for displaying clinical information, according to an embodiment of the present invention.

The foregoing summary, as well as the following detailed description of certain embodiments of the present application, will be better understood when read in conjunction with the appended drawings. For the purpose of illustrating the invention, certain embodiments are shown in the drawings. It should be understood, however, that the present invention is not limited to the arrangements and instrumentality shown in the attached drawings. Further, some figures may be representations of the type of display and/or output associated with methods and systems of the present invention, in accordance with one or more embodiments.

### DETAILED DESCRIPTION OF THE INVENTION

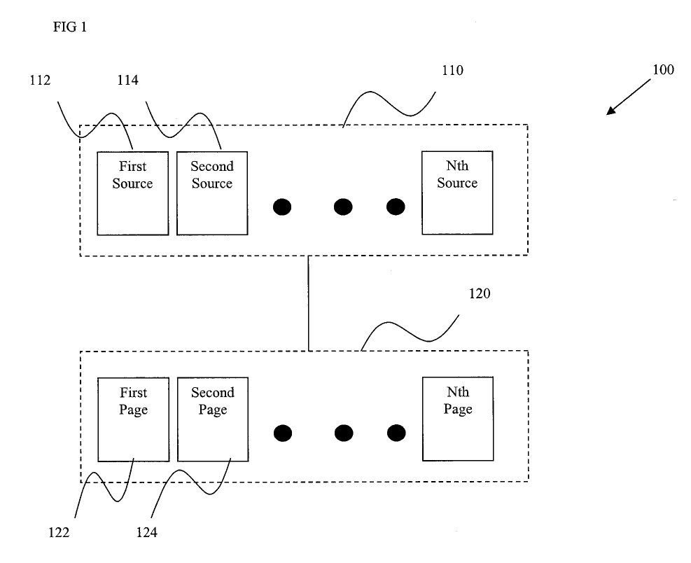

FIG. 1 shows a system for displaying clinical information, according to an embodiment of the present invention. The system 100 may include a plurality of clinical information sources 110 and a plurality of display pages 120.

The plurality of clinical information sources 110 may include a first source 112 and a second source 114. The clinical information sources 110 may be databases, for example. The sources 110 may include sources of linked clinical information. For example linked clinical information may be provided by external sources or databases, such as a medication management system (order, fulfill, and administer medications). The sources 110 may include unlinked clinical information. For example, unlinked clinical information may be provided by internal sources or databases, such as lab results, allergies, patient history, etc. The plurality of pages 120 may include a first page 122 and a second page 124.

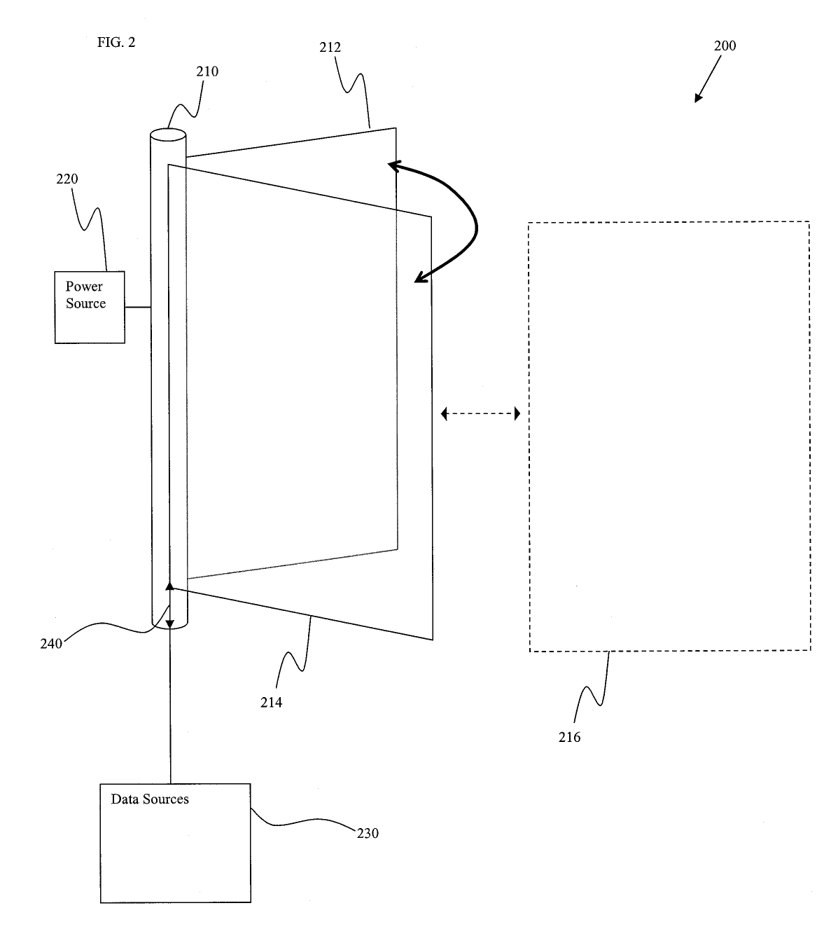

FIG. 2 shows an apparatus for displaying clinical information, according to an embodiment of the present invention. The apparatus 200 may include a first page 212, a second page 214, an axial portion 210, a power source 220, and a data conduit 240, for example. The pages may include additional pages, for example, similar to pages 120. Page 216 is illustrated as a detached page, as will be described further. Also, data sources 230, while not technically part of apparatus 200, are shown in FIG. 2 in accordance with an embodiment of the present invention.

The first page 212 and second page 214 may be capable of displaying information, such as clinical information, for example. The pages may be viewable by a clinician, for example. Each page may function as a separate display. Each page may dynamically display clinical information to a clinician. The pages may include organic light emitting diodes (OLEDs), for example. The pages may be formed in part from a substantially flexible material used as a substrate for OLEDs, for example. The pages may be capable of display with, or without the application of electrical power, for example.

The pages may be rotatably attached to the axial portion 210, for example. Each page may be detached from the axial portion 210. The pages may be detachable individually and/or collectively, for example. A removed page may not be supplied with electrical power, for example, but still may be capable of displaying information.

Each page may be capable of dynamically displaying clinical information to a clinician. The clinical information may come from two or more data sources 230, for example. Examples of sources of clinical information include: Computerized physician order entry systems, lab information systems, admission, discharge and transfer systems, outpatient clinical management systems, pharmacy information systems, picture archival and communications systems, etc.

For example, clinical information from a computerized physician order entry (CPOE) system may be dynamically displayed to a clinician on one or more of the pages. For example, a patient's medication may be dynamically displayed to a clinician on one or more pages according to a CPOE. As another example, a patent's medical record may be displayed on one or more pages. For example, medical records from an electronic medical record may be displayed on one or more pages.

The apparatus 200 may have an interface for permitting interaction with a clinician. For example, a clinician may be able to interact with information displayed on one or more of the pages. Various possible interfaces include: a keyboard; a mousing device; a touch screen; and/or the like, for example. Touch screens may be included in one or more of the pages, for example. The clinician may be able to interact through the interface with a display of information to dynamically update the display of information, for example. The clinician may also be able to interact with a display of information to enter additional information regarding a patient and/or the treatment of a patient, for example.

For example, a clinician may be able to interact with one or more pages of displayed clinical information with a CPOE system. For example, a clinician may update medications for a patient by interfacing with the displayed information from a CPOE system. For example, a clinician may select a medication to be prescribed, and enter the medication into apparatus 200 through the interface. The apparatus 200 may then dynamically update the display of clinical information according to the clinician's interaction. For example, a patient's medication may be dynamically displayed to a clinician on one or more pages according to a CPOE. As another example, a patent's medical record may be displayed on one or more pages. Similarly, the clinician may be able to interact with the apparatus to dynamically update the patient's medical record, for example. The updated medical record may, then, be dynamically displayed to the clinician, for example.

An axial portion 210 may be attached with one or more pages, for example. The pages may be rotatably attached to the axial portion 210, for example. A page may be rotatably attached through facilitation of a rotation portion (not shown), for example. A page may also be rotatably attached, in a manner similar to pages in a book, for example. A page may be attached to an axial portion 210, and may be flexible to facilitate rotatable attachment, for example. One or more of the pages may be detachable from the axial portion 210, for example. A detached page (e.g. 216) may be moved more freely by a clinician, for example.

The axial portion 210 may facilitate the provision of power to one or more of the pages through a power source 220, for example. The power source 220 may be one or more portable sources (e.g., batteries, fuel cells, solar cells, etc.), and/or may be of the plug-in variety (e.g., DC transformer, AC transformer, etc.), for example. The pages may be capable of dynamically updating the display of clinical information when power is provided from the power source 220, for example. The pages may also be capable of displaying clinical information without the provision of substantial power from the power source 220, for example.

A data conduit 240 may be capable of passing data to/from data sources 230 and the apparatus 200. For example, data conduit 240 may pass data from the source(s) 230 to the page(s). For example, data conduit 240 may pass data from the page(s) to the source(s).

The information displayed on the pages may further be configurable, for example. The manner and layout may be configured for one or more pages, for example. The display may be configurable through clinician interaction, or through additional ways, such as a networked computer, or physician preference information, for example. The display may be configurable according to a patient, or patient's treatment (e.g., cardiac patient, pulmonary patient, etc.).

The pages of apparatus 200 may facilitate a clinician to efficiently access and document different, electronically linked information by flipping through the pages, similar to a manner clinicians employ with paper charts, for example. Using apparatus 200, a clinician may efficiently switch among modules and/or various clinical systems as displayed on the pages, for example. Clinicians may use their fingers or other items to bookmark certain page(s) to facilitate back and forth flipping to other page(s).

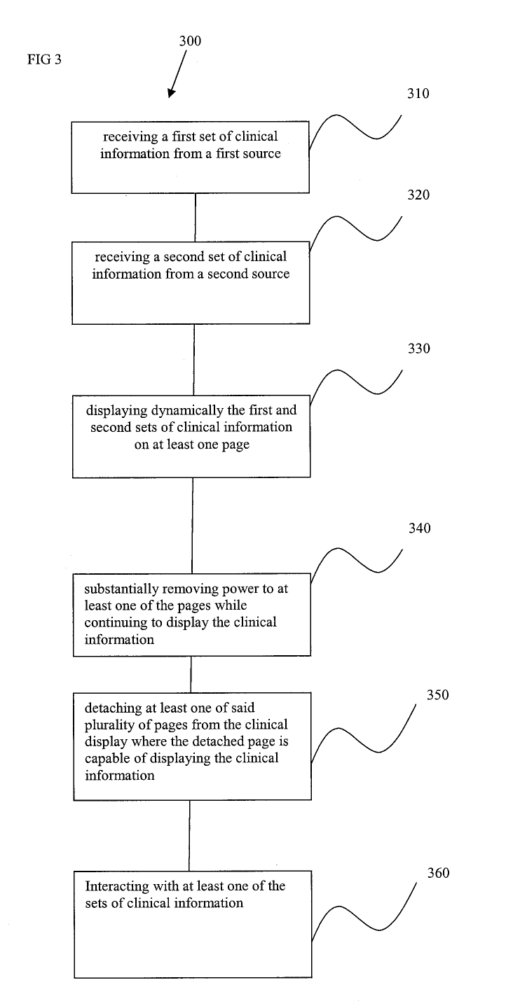

FIG. 3 shows a flowchart for a method 300 for displaying clinical information, according to an embodiment of the present invention. The steps of the method 300 may be performable, for example, by an apparatus, such as apparatus 200, at least in part. Furthermore, the steps of method 300 may be performable in a different order, or some steps may be omitted. For example, steps 340, 350, and 360 may be omitted. As another example, steps may be performed in a different order according to design and/or clinical preferences. Method 300, or a portion thereof, may be performable by one or more processing units. Method 300, or a portion thereof, may be performable by software, hardware, and/or firmware. Method 300, or a portion thereof, may also be expressible through a set of instructions stored on one of more computer-readable storage media, such as RAM, ROM, EPROM, EEPROM, optical disk, magnetic disk, magnetic tape, and/or the like.

At steps 310 and 320, a first and second set of clinical information may be received from a first and second source, respectively. For example, information may be received from sources, such as those illustrated and discussed in conjunction with FIGS. 1 and 2. The information may be linked or unlinked information, for example. The information may correspond to a patient and/or a patient's treatment, for example. The information may be received from a database and/or external server, for example. For example, the information may correspond to a CPOE system, or a patient's medical records. Lab information systems, admission, discharge and transfer systems, outpatient clinical management systems, pharmacy information systems, picture archival and communications systems, etc.

At step 330, the first and second information sets may be dynamically displayed on a plurality of pages. The information sets may be displayed on separate pages, or may be displayed together on particular pages, for example. It may be preferable, for example, to display only a portion of an information set on one or more pages. It may be preferable, for example, to display a portion of an information set on a first page, and a portion of the information set on a second page. The dynamic display may be capable of adapting the output to changing conditions of information—such as in response to a clinician's interaction, for example. The pages may be similar to those illustrated and discussed in conjunction with FIGS. 1 and 2.

At step 340, the power to at least one of the pages may be substantially removed. After removal of power, the substantially powerless page(s) may be capable of displaying clinical information. For example, a page that has an OLED display may be capable of displaying information without the substantial provision of power. Power may, however, facilitate a dynamic update of the display of clinical information, for example. Power may be substantially removed when a page is detached, as discussed below.

At step 350, one or more pages may be detached from the clinical display device. A page may be detachable, in that it may be detached and/or reattached to the clinical display device. For example, a page may be detachable and/or reattachable to an axial portion. The page may have a detachment mechanism to facilitate detachment from the clinical display device. A detached page may be freely moved by a clinician without need to move the clinical display device, for example.

At step 360, a clinician interacts with at least one of the sets of clinical information. A clinician may interact through an interface, as described above in conjunction with FIG. 2, for example. A clinician may select, move, alter, adjust, remove, delete, add, highlight, and/or otherwise interact with the clinical information, for example. The interaction may be temporary, or may be permanent, for example. The result of the interaction may be dynamically displayed on at least one of the pages, for example. The interaction may be communicated to at least one of the data sources (e.g. EMR), or an associated system to update the data source according to the interaction, for example.

As an example, method 300 may be performed in the following manner. At steps 310, clinical information is received from a patient's EMR. The patient's EMR includes information concerning several conditions that the patient has been diagnosed with. The diagnosed conditions are: a broken arm; a staph infection; and seizure disorder. The information is received into an clinical display apparatus, as described in conjunction with FIG. 2.

At step 320, clinical information regarding the patient is received from a CPOE system. The CPOE system information includes the prescribed medications for each of the patient's conditions—broken arm, staph infection, and seizure disorder. The information is received into an clinical display apparatus, as described in conjunction with FIG. 2. The information available to the caregiver on the display may come from different computerized systems that may not share a common repository of information. For example, the existing conditions of a patient may come from an EMR system populated with clinical information about the patient through previous out-patient visits to a physician's clinic. Other “unlinked” information would be displayed from an in-hospital system and would include specific visit information such as presenting symptoms, medications prescribed and administered, lab results, etc. Such information, while hosted on separate clinical systems may be integrated at the bed side via the multi-page display.

At step 330, the EMR and the CPOE information sets are dynamically displayed on 3 pages. Each of the pages is a flexible display using OLED display technology. The displays are configured to show one condition on a page, along with the corresponding prescribed medication. On page 1, the details of the patient's broken arm (e.g. previous diagnoses, radiology reports, etc.) are shown, along with the prescribed pain medication. On page 2, the details of the patient's staph infection (e.g. lab reports, patient temperature, etc.) are shown, along with the prescribed antibiotics. On page 3, the details of the patient's seizure disorder (e.g. EEG reports, etc.) are shown, along with the prescribed anti-seizure medication.

At steps 340 and 350, a treating doctor decides to consult an on-duty radiologist about the patient's arm condition. To facilitate, the doctor detaches page 1 from the clinical display apparatus, and walks over with the page to the on-duty radiologist. The detached page, now without power, still displays the clinical information discussed above. The doctor discusses the patient's broken arm condition with the radiologist. The radiologist suggests an altered approach to the treatment of the broken arm. The doctor then returns the page to the clinical display device, and reattaches it.

At step 360, the doctor interacts through a touch-screen interface with the clinical information displayed on page 1. The doctor interacts by adjusting the treatment approach to the patient's broken arm, according to the radiologists suggestion. The clinical display apparatus then communicates the new information to the CPOE system and the EMR system. The systems update the first and second sources of information, according to the new information. The new information is dynamically displayed on page 1.

Thus, embodiments of the present invention provide convenient management of clinical information. Embodiments of the present invention provide clinical information management in a relatively small factor. Embodiments of the present invention lower the resistance threshold of clinical caregivers and speed the adoption of computerized clinical systems. Embodiments of the present invention provide mechanical navigation that is more natural to clinicians. Embodiments of the present invention ease the burden of data interoperability among multiple clinical data sources.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. For example, features may be implemented with software, hardware, or a mix thereof. Therefore, it is intended that the invention not be limited to the particular embodiment disclosed, but that the invention will include all embodiments falling within the scope of the appended claims.

1. A system for presenting clinical information comprising:
a plurality of pages for displaying clinical information; and
a plurality of sources for said clinical information, wherein each of said pages is capable of receiving information from at least one of said sources, and each of said pages is capable of dynamically updating the display of said clinical information.

2. The system of claim 1, wherein said plurality of pages are capable of displaying said clinical information without substantial electrical power.

3. The system of claim 1, wherein each of said plurality of pages is flexible.

4. The system of claim 3, wherein each of said plurality of pages comprise organic light emitting diodes.

5. The system of claim 1, wherein said clinical information comprises linked clinical data corresponding to a patient.

6. The system of claim 1, wherein said clinical information comprises unlinked clinical data corresponding to a patient.

7. The system of claim 1, wherein said clinical information comprises clinical data corresponding to a patient, said clinical data further comprising plurality of sources, said sources further comprising at least two of: a lab result, an allergy report, a patient history, and a medication management system report.

8. An apparatus for presenting clinical information comprising:
an axial portion;
a first page for viewing by a clinician, said page rotatably attached to said axial portion;
a second page for viewing by said clinician, said second page rotatably attached to said axial portion; and
at least one data conduit for receiving clinical information into the apparatus from a plurality of sources,
wherein said clinical information is dynamically displayed on at least one of: said first page, and said second page.

9. The apparatus of claim 8, wherein each of said first and second pages is capable of displaying said clinical information without substantial electrical power.

10. The apparatus of claim 8, wherein each of said first and second pages is flexible.

11. The apparatus of claim 10, wherein each of said first and second pages comprise organic light emitting diodes.

12. The apparatus of claim 8, wherein at least one of said first and second pages is detachable from said axial portion, and is capable of displaying said clinical information while detached.

13. The apparatus of claim 8, wherein said clinical information comprises clinical data corresponding to a patient, said clinical data further comprising plurality of sources, said sources further comprising at least two of: a lab result, an allergy report, a patient history, and a medication management system report.

14. The apparatus of claim 8 further comprising an interface for permitting interaction with said clinician to alter a display of at least one of said first and second pages.

15. The apparatus of claim 14, wherein said interface comprises a touch screen in at least one of said first and second pages.

16. The apparatus of claim 8, wherein said first and second pages are capable of displaying at least one of: linked clinical information, and unlinked clinical information.

17. A method for displaying clinical information comprising:
receiving a first set of clinical information from a first source;
receiving a second set of clinical information from a second source; and
displaying dynamically said first and second sets of clinical information on a plurality of pages,
wherein said plurality of pages are attachably linked to a clinical display device.

18. The method of claim 17 further comprising substantially removing power to at least one of said plurality of pages to display at least one of said first and second sets of clinical information.

19. The method of claim 17 further comprising detaching at least one of said plurality of pages from said clinical display device to form a detached page, wherein said detached page is capable of displaying at least one of said first and second sets of clinical information.

20. The method of claim 17 further comprising interacting with at least one of said sets of clinical information.
